(19) United States
(12) Patent Application Publication
(10) Pub. No.: US 2013/0334454 A1
(43) Pub. Date: Dec. 19, 2013

(54) FORMULATIONS OF PRINTABLE ALUMINIUM OXIDE INKS

(71) Applicants: Ingo Koehler, Reinheim (DE); Oliver Doll, Dietzenbach (DE); Werner Stockum, Reinheim (DE); Sebastian Barth, Darmstadt (DE)

(72) Inventors: Ingo Koehler, Reinheim (DE); Oliver Doll, Dietzenbach (DE); Werner Stockum, Reinheim (DE); Sebastian Barth, Darmstadt (DE)

(73) Assignee: MERCK PATENT GMBH, Darmstadt (DE)

(21) Appl. No.: 14/002,744

(22) PCT Filed: Feb. 9, 2012
(86) PCT No.: PCT/EP2012/000591

§ 371 Date: Sep. 3, 2013

(30) Foreign Application Priority Data
Mar. 8, 2011 (EP) 11001920.5
Sep. 6, 2011 (EP) 11007207.1

(51) Int. Cl. C09D 11/02

(52) U.S. Cl. CPC C09D 11/02
USPC 252/62.3 Q; 423/625; 106/31.13; 252/62.3 GA; 438/778; 427/58

(57) ABSTRACT

The present invention relates to the use of printable inks for the formation of Al₂O₃ coatings or mixed Al₂O₃ hybrid layers, and to a corresponding process for the formation thereof.

The present invention relates to the use of printable inks for the formation of Al₂O₃ coatings or mixed Al₂O₃ hybrid layers, and to a corresponding process for the formation thereof.

The synthesis of sol-gel-based layers is attaining ever greater importance in industrial production owing to their variety of possible uses. Thus, the following functional layers or surface finishes and modifications can be built up or carried out by means of sol-gel technology:
antireflection coatings, for example for optical components and the like
corrosion-protection coatings, for example of steels and the like
scratch-protection coatings
surface seals
hydrophobisation or hydrophilisation of surfaces
synthesis of membranes and membrane materials
synthesis of support materials for catalytic applications
precursors of sinter ceramics and sinter-ceramic components
dielectric layers for electronic and microelectronic components having the following special applications, where the formation of one of the desired functionalities may be, but does not have to be, linked to specific heat treatment, such as, for example, in a stream of O₂, N₂, O₂/N₂ and/or forming gas:
   spin-on-glass (“SoG”) in the manufacture of integrated circuits
   dielectric buffer layers between individual metallisation planes in the manufacture of integrated circuits (“porous MSQ”)
   printable dielectric layers for printed circuits, printable electronics in general and printable organic electronics in particular
   printable dielectric layers for electric switches and circuits
diffusion-barrier layers (WO 2009/118083 A2)
   for semiconductors in general
   for silicon in particular, and especially for silicon wafers, and in particular for those for the production of crystalline silicon solar cells
   matrices for the binding of dopants (for example B, Ga, P, As, etc.) for the specific full-area and/or local doping of
   semiconductors in general
   silicon in particular and especially for silicon wafers and in particular for those for the production of crystalline silicon solar cells
   electronic passivation of semiconductor surfaces in general and of silicon in particular.

This list only represents a selection of the various possible applications.

Most sol-gel processes known from the literature are based on the use of silicon and alkoxides thereof (siloxanes), the specific hydrolysis and condensation of which enables networks having various properties and coatings which can be derived therefrom to be synthesised very easily, and smooth or porous films, but also films in which particles are embedded, can be produced.

For use, in particular in the solar sector, sol-gel-based layers have to meet particular requirements. These should also be taken into account in the formulation of compositions which can be employed for the production of such layers. Inks are particularly suitable, in particular, for the production of the requisite thin layers. However, specific requirements should be made of the composition of the inks, so that the layers to be produced attain the desired basic properties through the synthesis and the starting materials employed:

on the one hand, suitable solvents having properties which are advantageous for the use should be selected, such as, for example, no to low toxicity or adequate surface wetting. Furthermore, corrosive anions (Cl⁻ or NO₃⁻, etc.) should not be present in the inks, since they would greatly limit the possible uses of the inks. Corresponding inks could, for example, corrode the printing and deposition equipment used, but also later promote corrosion in an undesired manner, such as, for example, of solder contacts when connecting up solar cells which are provided with such layers, which would consequently result in limited long-term stability of crystalline silicon solar modules.

Besides aqueous inks named according to Yoldas, many examples of ionically and sterically stabilised inks are known from the literature [1-3].

Özer et al. [1] and Felde et al. [2] describe homogeneous film formation on silicon wafers or diamonds by a sterically/anionically stabilised sol. The occurrence of precipitates in the case of sols stabilised only with acetylacetone (without HNO₃) is investigated by Nass et al. [3]. They additionally show that the use of ethyl acetoacetate in an alcoholic aluminium alkoxide solution enables the hydrolysis to be controlled, and ageing of the sols with precipitate formation and gelling does not occur.
[1] N. Özer, J. P. Cronin, Y. Yao, A. P. Tomsia, Solar Energy Materials & Solar Cells 59 (1999) 355-366
[2] B. Felde, A. Mehner, J. Kohlscheen, R. Glabe, F. Hoffmann and P. Mayr, Diamond and Related Materials, 10 (2001), 515-518
[3] R. Nass, H. Schmidt, Journal of non-crystalline Solids, 121 (1990), 329-333

Besides the omission of stabilising and corrosive ions, the inks should, in particular, be suitable for use as diffusion barrier and should be able to form impermeable layers, i.e. layers which are impermeable to diffusion by the dopant used in each case. Furthermore, the inks should be stable on storage over an extended period in order to be able to decouple their use from the synthesis of the inks. In the case of inks which are not ionically stabilised, the literature usually reports on low long-term stability or the formation of stabilised particles which result in porous layers.

Only sols comprising ethyl acetoacetate or triethanolamine exhibit sufficiently high long-term stability with the particle size remaining small. On the other hand, sols can be synthesised as long-term-stable sols without the addition of water.

Gonzales-Pena et al. [4] and Tadanaga et al. [6] have shown that ASB modified with triethanolamine has high stability to hydrolysis. In addition, they concluded from the gel structure and from investigations in solution that impermeable layers can be formed by the well-stabilised particles with a low degree of branching. Mizushima et al. [5] and Tadanaga et al. [6] have additionally investigated the hydrolysis and structure of ethyl acetoacetate-modified ASB gels. Ethyl acetoacetate-modified gels exhibit a long-term stability of >1000 h under certain conditions, but very low stability of in some cases <1 h in the case of a somewhat higher water content, which is why they can be classified as moderately stable under standard conditions. However, since alcoholic sols have only mediocre coating properties, sols comprising glycol ethers as solvents are preferred. Bahlawane [8] describes, for example, the synthesis of an aluminium oxide sol in diethylene glycol monoethyl ether, but under anhydrous conditions, since otherwise precipitate formation presumably occurs. The stability under room conditions (atmospheric humidity) can presumably be explained by the relatively hydrophobic medium [4-8].
[4] V. Gonzales-Pena, C. Marquez-Alvarez, I. Diaz, M. Grande, T. Blasco, J. Perez-Pariente, Microporous and Mesoporous Materials 80 (2005) 173-182
[5] Y. Mizushima, M. Hori, M. Saski Journal of Material Research, 8 (1993), 2109-2111
[6] K. Tadanaga, S. Ito, T. Minami, N. Tohge, Journal of Sol-Gel Science and Technology, 3 (1994), 5-10
[7] K. Tadanaga, S. Ito, T. Minami, N. Tohge, Journal of Non-Crystalline Solids, 201 (1996), 231-236
[8] N. Bahlawane, Thin Solid Films, 396 (2001), 126-130

The above-mentioned and desired properties also apply to so-called hybrid sols. Hybrid sols are taken to mean sols which are built up from various precursors and can result in network formation. In general, use is also made here of alkoxides, as also shown in the examples. However, suitable compounds are all organoaluminium compounds or, if coatings are to be produced from mixtures of various metal oxides, corresponding organometallic compounds which can be converted into the corresponding metal oxides in the presence of water under acidic conditions, in particular at a pH in the range 4-5. Suitable hybrid materials are binary mixtures consisting of Al₂O₃ and the oxides, hydroxides and alkoxides of, for example, boron, gallium, silicon, germanium, zinc, tin, phosphorus, titanium, zirconium, yttrium, nickel, cobalt, iron, cerium, niobium, arsenic, lead and others. The limiting properties of the formation of an impermeable, compact layer based on long-term-stable, non-ionically stabilised layers also apply thereto. In addition, hybrid sols based on ternary and quaternary mixtures of the oxides and alkoxides of the above-mentioned elements are possible [9 and 10].
[9] F. Babonneau, L. Coury, J. Livage, Journal of Non-Crystalline Solids, 121 (1990), 153-157
[10] G. Zhao, N. Tohge, Materials Research Bulletin, 33 (1998), 21-30

Further syntheses of Al₂O₃ inks based on sol-gel reactions include anhydrous media, in which an extended storage time is possible only under controlled conditions, but which are rather unsuitable for uniform hydrolysis in the presence of atmospheric humidity, which is necessary for the formation of homogeneous layers, and is difficult to carry out from a technical point of view.

Furthermore, hydrothermal syntheses of aluminium oxide hybrid materials are suitable, but these do not give an ink which is suitable for coating.

### OBJECT

In spite of the variety of possible uses of SiO₂ layers and the various ways of varying the properties of such layers, it is desirable to be able to have available alternative coatings having comparable properties which result in novel and improved properties of the coated surfaces. It is thus an object of the present invention both to provide a process for the production of alternative layers of this type and also facilitate the use of novel compositions of this type for the production of thin barrier layers or diffusion layers.

Through experiments and investigation of the properties, it has been found that Al₂O₃ can be used in a similar manner and applied in thin layers to surfaces like SiO₂. Through these experiments, it has also been found that the use of Al₂O₃ represents a highly promising replacement for SiO₂ layers. Besides the above-mentioned suitability either as diffusion barrier and/or as sol-gel-based doping source, Al₂O₃ is also suitable for use as mechanical protection layer owing to the hardness of its crystalline modifications.

It is thus also an object of the present invention to develop a stabilised, printable aluminium oxide sol while avoiding anions such as, for example, chloride and nitrate, which on the one hand have a stabilising action, but are highly corrosive and adversely affect the usability, but with simultaneous retention of the long-term stability of the sol.

A further object of the invention is to develop a corresponding aluminium sol which forms an impermeable, i.e. diffusion-impermeable or -resistant, smooth, non-porous layers on the surface of silicon wafers.

### Subject-Matter of the Invention

The object is achieved by the use of printable, sterically stabilised inks for the formation of Al₂O₃ coatings or mixed Al₂O₃ hybrid layers. Inks according to the invention can consist of precursors for the formation of Al₂O₃ and one or more oxides of the elements selected from the group boron, gallium, silicon, germanium, zinc, tin, phosphorus, titanium, zirconium, yttrium, nickel, cobalt, iron, cerium, niobium, arsenic and lead oxides, where the inks are obtained by the introduction of corresponding precursors. Preference is given to the use of sterically stabilised inks which are obtained by mixing with at least one hydrophobic component and at least one hydrophilic component, and optionally with at least one chelating agent. Furthermore, these inks preferably comprise at least one hydrophobic component selected from the group 1,3-cyclohexadione, salicylic acid and structurally related compounds, and at least one moderately hydrophilic compound selected from the group acetylacetone, dihydroxybenzoic acid and trihydroxybenzoic acid or structurally related compounds thereof, chelating agents, such as ethylenediaminetetraacetic acid (EDTA), diethylenetriaminepentaacetic acid (DETPA), nitrilotriacetic acid (NTA), ethylenediaminetetramethylenephosphonic acid (EDTPA) and diethylenetriaminepentamethylenephosphonic acid (DETPPA) or structurally related complexing agents or corresponding chelating agents. Besides these components, the inks used comprise solvents selected from the group of low-boiling alcohols, preferably selected from the group ethanol and isopropanol, and at least one high-boiling alcohol selected from the group of high-boiling glycol ethers, preferably selected from the group diethylene glycol monoethyl ether, ethylene glycol monobutyl ether and diethylene glycol monobutyl ether, or mixtures thereof, and optionally polar solvents selected from the group acetone, DMSO, sulfolane and ethyl acetate, or similar polar solvents. Particularly advantageous is the use according to the invention of corresponding inks which have an acidic pH in the range 4-5, preferably less than 4.5, and comprise, as acids, one or more organic acids which result in residue-free drying. Particular preference is given to the use of these inks for the formation of impermeable, homogeneous layers, to which water for hydrolysis is added in the molar ratio of water to precursor in the range from 1:1 to 1:9, preferably between 1:1.5 and 1:2.5, where the solids content is in the range 0.5 to 10% by weight, preferably in the range between 1 and 6% by weight. In particular, these inks can be used for the production of diffusion barriers, printed dielectrics, electronic and electrical passivation, antireflection layers, mechanical protection layers against wear, or chemical protection layers against oxidation or the action of acid. On the other hand, these inks are advantageously suitable for use for the preparation of hybrid materials comprising simple and polymeric boron and phosphorus oxides and alkoxides thereof, which are suitable for the full-area and local doping of semiconductors, preferably silicon, or Al₂O₃ layers, which act as sodium and potassium diffusion barriers in LCD technology. If the Al₂O₃ inks according to the invention are employed for the production of boron-doped layers, the composition of the sol-gel composition is set in such a way that hybrid layers having a boron trioxide content in the range 5-55 mol %, preferably in the range 20-45 mol %, are obtained.

The present invention also relates, in particular, to a process for the production of pure, residue-free, amorphous Al₂O₃ layers on mono- or multicrystalline silicon wafers, sapphire wafers, thin-film solar modules, glasses coated with functional materials (for example ITO, FTO, AZO, IZO or the like), uncoated glasses, steel elements and alloys, and on other materials used in microelectronics, in which, after application of a thin layer of the ink according to the invention, the drying is carried out at temperatures between 300 and 1000° C., preferably at 300 to 450° C. The surface to which the sol-gel ink is applied may be in hydrophobically or hydrophilically terminated form and is cleaned before application of the ink, preferably by etching with HF solution or by simple washing with water (rinsing).

Drying and heat treatment of the applied inks at temperatures from 1000° C. no longer gives only amorphous layers, but produces hard, crystalline layers having comparable properties to corundum.

Application of a suitable amount of ink gives, over the course of a drying time of a few minutes, preferably over the course of less than 5 minutes, an Al₂O₃ layer having a layer thickness in the range from 20 to 300 nm, preferably of less than 100 nm, which has a passivating action on surfaces. The process according to the invention preferably enables pure, residue-free, amorphous, structurable Al₂O₃ layers to be produced if, after application of a thin layer of ink, the drying is carried out at temperatures in the range from 300° C. and 550° C., preferably at temperatures in the range from 350 to 500° C. Corresponding layers produced by means of inks which can be applied in a structured manner can be etched using most inorganic mineral acids, but preferably by HF and H₃PO₄, and by many organic acids, such as acetic acid, propionic acid and the like, and subsequently structured.

The sol-gel process according to the invention at temperatures below 400° C. in a combined drying and heat treatment gives stable and smooth layers which are free from organic contaminants.

### DETAILED DESCRIPTION OF THE INVENTION

Al₂O₃ inks sterically stabilised in accordance with the invention having an acidic pH in the range 4-5, preferably of less than 4.5, based on alcoholic and polyoxylated solvents having very good wetting and adhesion properties to SiO₂ and silane-terminated silicon wafer surfaces can advantageously be employed for the formation of homogeneous, impermeable, i.e. diffusion-impermeable, layers.

A layer of this type is shown in FIGS. 1a and 1b in the form of a scanning electron photomicrograph of an Al₂O₃ layer produced in accordance with the invention on a polished (100) silicon wafer and the associated EDX analysis.

If the drying in the process according to the invention is carried out above 300° C., an amorphous Al₂O₃ layer which is free from organic impurities forms. This has been demonstrated by Raman spectroscopy. FIG. 2 shows a temperature-dependent Raman analysis of a resultant Al₂O₃ layer on a polished (100) silicon wafer.

For the formulation of the aluminium sol employed in accordance with the invention as ink, corresponding alkoxides of aluminium can be used. These can be aluminium triethoxide, aluminium triisopropoxide and aluminium tri-sec-butoxide. Alternatively, readily soluble hydroxides and oxides of aluminium can also be used for this purpose.

The alkoxides are dissolved in a suitable solvent mixture. This solvent mixture may be composed both of polar protic solvents and also polar aprotic solvents, and mixtures thereof. In addition and in accordance with the pre-specified application conditions, the solvent mixtures can be adapted within broad limits to the desired conditions and properties of the coatings, for example with respect to their wetting behaviour, by the addition of non-polar solvents. Suitable polar protic solvents can be:
aliphatic, saturated and unsaturated, mono- to polybasic, functionalised and non-functionalised alcohols,
   such as methanol, ethanol, propanol, butanol, amyl alcohol, propargyl alcohol and homologues having up to 10 C atoms (C≦10)
   such as alkylated, secondary and tertiary alcohols with any desired degree of branching, such as, for example, isopropanol, 2-butanol, isobutanol, tert-butanol and homologues thereof, preferably isopropanol and 2-butanol
   such as glycol, pinacols, 1,2-propanediol, 1,3-propanediol, 1,2,3-propane-triol and further branched homologues
   such as monoethanolamine, diethanolamine and triethanolamine
glycol ethers and condensed glycol ethers, and propylene glycol ethers and condensed propylene glycol ethers, and branched homologues thereof
   such as methoxyethanol, ethoxyethanol, propoxyethanol, butoxyethanol, pentoxyethanol, phenoxyethanol and others
   diethylene glycol, diethylene glycol monomethyl ether, diethylene glycol monoethyl ether, diethylene glycol monopropyl ether, diethylene glycol monobutyl ether, diethylene glycol monopentyl ether, diethylene glycol dimethyl ether, diethylene glycol diethyl ether, diethylene glycol dipropyl ether, diethylene glycol dibutyl ether, diethylene glycol dipentyl ether and others,
   propylene glycol, methoxy-2-propanol, propylene glycol monomethyl ether, propylene glycol dimethyl ether, propylene glycol monoethyl ether, propylene glycol diethyl ether, phenoxypropylene glycol and others.

Suitable polar aprotic solvents can be:
dimethyl sulfoxide, sulfolane, 1,4-dioxane, 1,3-dioxane, acetone, acetylacetone, dimethylformamide, dimethylacetamide, ethyl methyl ketone, diethyl ketone and others.

In the case of the use of aluminium alkoxides, the synthesis of the sol furthermore requires the addition of water in order to achieve hydrolysis of the aluminium nuclei and commencing precondensation thereof. The water required can be added in sub- to superstoichiometric amounts. Sub-stoichiometric addition is preferred.

The alkoxides liberated on hydrolysis of the aluminium nuclei are converted into the corresponding alcohols by addition of an organic acid and/or mixtures of organic acids. The acid or acid mixture is added in such a way that a pH in the range 4-5, preferably less than 4.5, can be achieved. In addition, the added acid and/or acid mixture acts as catalyst for the precondensation and the crosslinking commencing therewith of the aluminium nuclei hydrolysed in the solution. Suitable organic acids for this purpose can be:
formic acid, acetic acid, acetoacetic acid, trifluoroacetic acid, monochloro- to trichloroacetic acid, phenoxyacetic acid, glycolic acid, pyruvic acid, glyoxylic acid, oxalic acid, propionic acid, chloropropionic acid, lactic acid, β-hydroxypropionic acid, glyceric acid, valeric acid, trimethylacetic acid, acrylic acid, methacrylic acid, vinylacetic acid, crotonic acid, isocrotonic acid, glycine and further α-amino acids, β-alanine, malonic acid, succinic acid, maleic and fumaric acid, malic acid, tartronic acid, mesoxalic acid, acetylenedicarboxylic acid, tartaric acid, citric acid, oxalacetic acid, benzoic acid, alkylated and halogenated, nitrated and hydroxylated benzoic acids, such as salicylic acid, and further homologues,

The aluminium sol can be stabilised either by the above-mentioned organic acids and/or mixtures thereof, or alternatively by the specific addition of complexing and/or chelating additives, or the stability of the aluminium sol can be increased by addition thereof. Complexing agents for aluminium which can be used are the following substances:
nitrilotriacetic acid, nitrilotris(methylenephosphonic acid). ethylenediaminetetraacetic acid, ethylenediaminetetrakis(methylenephosphonic acid), diethylene glycol diaminetetraacetic acid, diethylenetriaminepentaacetic acid, diethylene glycol triaminetetrakis(methylenephosphonic acid), diethylenetetraminepentakis(methylenephosphonic acid), triethylenetetraminehexaacetic acid, triethylenetetraminehexakis(methylenephosphonic acid), cyclohexanediaminetetraacetic acid, cyclohexanediaminetetrakis(methylenephosphonic acid), etidronic acid, iminodiacetic acid, iminobis(methylenephosphonic acid), hex amethylenediaminetetrakis(methylenephosphonic acid), MIDA, MIDAPO, hydroxyethyliminodiacetic acid, hydroxyethylethylenediaminetetraacetic acid, trimethylenedinitrilotetraacetic acid, 2-hydroxytrimethylenedinitrilotetraacetic acid, maltol, ethylmaltol, isomaltol, kojic acid, mimosine, mimosinic acid, mimosine methyl ether, 1,2-dimethyl-3-hydroxy-4-pyridinone, 1,2-diethyl-3-hydroxy-4-pyridinone, 1-methyl-3-hydroxy-4-pyridinone, 1-ethyl-2-methyl-3-hydroxy-4-pyridinone, 1-methyl-2-ethyl-3-hydroxy-4-pyridinone, 1-propyl-3-hydroxy-4-pyridinone, 3-hydroxy-2-pyridinones, 3-hydroxy-1-pyridinethiones, 3-hydroxy-2-pyridinethiones, lactic acid, maleic acid, D-gluconic acid, tartaric acid, 8-hydroxyquinoline, catechol, 1,8-dihydroxynaphthalene, 2,6-dihydroxynaphthalene, naphthalic acid (naphthalene-1,8-dicarboxylic acid), 3,4-dihydroxynaphthalene, 2-hydroxy-1-naphthoic acid, 2-hydroxy-3-naphthoic acid, dopamine, L-dopa, desferal or desferriferrioxamine-B, acetonehydroxamic acid, 1-propyl- and 1-butyl- and 1-hexyl-2-methyl-3-hydroxy-4-pyridinone, 1-phenyl- and 1-p-tolyl- and 1-p-methoxyphenyl and 1-p-nitrophenyl-2-methyl-3-hydroxy-4-pyridinone, 2-(2′-hydroxyphenyl)-2-oxazoline, 2-(2′-hydroxyphenyl)-2-benzoxazole, 2,X-dihydroxybenzoic acid (where X=3, 4, 5, 6), other alkylated, halogenated, nitrated 2,X-dihydroxybenzoic acids, salicylic acid and alkylated, halogenated and nitrated derivatives thereof, such as 4-nitro- and 5-nitrosalicyic acid, 3,4-dihydroxybenzoic acid, other alkylated, halogenated, nitrated 3,4-dihydroxybenzoic acids, 2,3,4-trihydroxybenzoic acid, other alkylated, halogenated, nitrated 2,3,4-trihydroxybenzoic acids, 2,3-dihydroxyterephthalic acid, other alkylated, halogenated, nitrated 2,3-dihydroxyterephthalic acids, mono-, di- and trihydroxyphthalic acids, and other alkylated, halogenated, nitrated derivatives thereof, 2-(3′,4′-dihydroxyphenyl)-3,4-dihydro-2H-1-benzopyran-3,5,7-triol (component from tannin), malonic acid, oxydiacetic acid, oxalacetic acid, tartronic acid, malic acid, succinic acid, hippuric acid, glycolic acid, citric acid, tartaric acid, acetoacetic acid, ethanolamines, glycine, alanine, β-alanine, alaninehydroxamic acid, α-aminohydroxamic acids, rhodotorulic acid, 1,1′,1″-nitrilo-2-propanol, N,N-bis(2-hydroxyethyl)glycine, bis(2-hydroxyethyl)iminotris(hydroxymethyl)methane, N-(tris(hydroxymethyl)-methyl)glycine, ethylenediaminetetra-2-propanol, N,N-bis(2-hydroxyethyl)-2-aminoethanesulfonic acid, N-(tris(hydroxymethyl)methyl)-2-aminoethanesulfonic acid, pentaerythritol, N-butyl-2,2′-iminodiethanol, monoethanolamine, diethanolamine, triethanolamine, acetylacetone, 1,3-cyclohexanedione, and further substituted (or alkylated, halogenated, nitrated, sulfonated, carboxylated) homologues and derivatives of the above-mentioned complexing and chelating agents, and salts thereof, preferably ammonium salts, and
further complexing and chelating agents which are able to coordinate Al.

Furthermore, further additives can be added to the aluminium sol for specific setting of the desired properties, which can be, for example, an advantageous surface tension, viscosity or improved wetting and drying behaviour and improved adhesion.

Such additives can be:
surfactants, surface-active compounds for influencing the wetting and drying behaviour,
antifoams and deaerating agents for influencing the drying behaviour,
further high- and low-boiling polar protic and aprotic solvents for influencing the particle-size distribution, the degree of precondensation, the condensation, wetting and drying behaviour and the printing behaviour,
further high- and low-boiling non-polar solvents for influencing the particle-size distribution, the degree of precondensation, the condensation, wetting and drying behaviour and the printing behaviour,
polymers for influencing the rheological properties (structural viscosity, thixotropy, flow limits, etc.),
particulate additives for influencing the rheological properties,
particulate additives (for example aluminium hydroxides and aluminium oxides, silicon dioxide) for influencing the dry-film thicknesses resulting after drying, and the morphology thereof,
particulate additives (for example aluminium hydroxides and aluminium oxides, silicon dioxide) for influencing the scratch resistance of the dried films,
oxides, hydroxides, basic oxides, alkoxides, precondensed alkoxides of boron, gallium, silicon, germanium, zinc, tin, phosphorus, titanium, zirconium, yttrium, nickel, cobalt, iron, cerium, niobium, arsenic, lead and others for the formulation of hybrid sols,
in particular simple and polymeric oxides, hydroxides, alkoxides of boron and phosphorus for the formulation of formulations which have a doping action on semiconductors, in particular silicon.

The aluminium sol is advantageously printable and can be applied to surfaces, preferably silicon wafer surfaces, by means of various printing processes. Printing processes of this type can, in particular, be the following:
spin or dip coating, drop casting, curtain or slot-dye coating, screen or flexo printing, gravure or ink-jet or aerosol-jet printing, offset printing, micro contact printing, electrohydrodynamic dispensing, roller or spray coating, ultrasonic spray coating, pipe jetting, laser transfer printing, pad printing, rotation screen printing and others.
This list should not be regarded as definitive, and further methods for printing or selective application of the inks according to the invention are additionally possible.

In this connection, it goes without saying that each printing and coating method will make its own requirements of the ink to be printed and/or the paste resulting from the ink. Certain parameters should typically be set individually for the respective printing method, for example the surface tension, the viscosity and the total vapour pressure of the ink, which arises from the composition of the paste.

Besides their use as scratch-protection and corrosion-protection layers, such as, for example, in the production of components in the metal industry, the printable inks and pastes can preferably be used in the electronics industry, and in particular here in the manufacture of microelectronic, photovoltaic and microelectromechanical (MEMS) components. Photovoltaic components in this connection are taken to mean, in particular, solar cells and modules. Applications in the electronics industry are furthermore possible by using the inks and pastes described in the following areas, which are mentioned by way of example, but are not listed comprehensively:

manufacture of thin-film solar cells from thin-film solar modules,
production of organic solar cells,
production of printed circuits and organic electronics,
production of display elements based on the technologies of thin-film transistors (TFTs), liquid crystals (LCDs), organic light-emitting diodes (OLEDs) and contact-sensitive capacitive and resistive sensors.

The present invention thus also consists, in particular, in the provision of printable, sterically stabilised inks for the formation of Al₂O₃ coatings and mixed Al₂O₃ hybrid layers.

Suitable hybrid materials are mixtures of Al₂O₃ with oxides of the elements boron, gallium, silicon, germanium, zinc, tin, phosphorus, titanium, zirconium, yttrium, nickel, cobalt, iron, cerium, niobium, arsenic and lead, where the inks are obtained by the introduction of the corresponding precursors into the ink liquid. Steric stabilisation of the inks is effected here by mixing with hydrophobic components, such as 1,3-cyclohexadione, salicylic acid and structural relatives thereof, and moderately hydrophilic components, such as acetylacetone, dihydroxybenzoic acid, trihydroxybenzoic acid and structural relatives thereof, or with chelating agents, such as ethylenediaminetetraacetic acid (EDTA), diethylenetriaminepentaacetic acid (DETPA), nitrilotriacetic acid (NTA), ethylenediaminetetramethylenephosphonic acid (EDTPA), diethylenetriaminepentamethylenephosphonic acid (DETPPA) and structurally related complexing agents or chelating agents.

Solvents which can be employed in the inks are mixtures of at least one low-boiling alcohol, preferably ethanol or isopropanol, and a high-boiling glycol ether, preferably diethylene glycol monoethyl ether, ethylene glycol monobutyl ether or diethylene glycol monobutyl ether. However, other polar solvents, such as acetone, DMSO, sulfolane or ethyl acetate and the like, can also be used. The coating property of the ink can be matched to the desired substrate through its mixing ratio. Addition of acids produces an acidic pH in the inks, preferably in the range pH 4-5). The acid used for adjustment of the pH can be organic acids, preferably acetic acid, which result in residue-free drying.

For the formation of the desired impermeable, homogeneous layer, water for hydrolysis is added, where the molar ratio of water to precursor should be between 1:1 and 1:9, preferably between 1:1.5 and 1:2.5.

In order to prepare the inks according to the invention, the layer-forming components are employed in a ratio such that the solids content of the inks is between 0.5% by weight and 10% by weight, preferably between 1% by weight and 6% by weight.

Suitable formulation of the compositions gives inks which have a storage stability of >3 months, where no detectable changes in the inks with respect to viscosity, particle size or coating behaviour are detectable within this time.

The residue-free drying of the inks after coating of the surfaces results in amorphous Al₂O₃ layers, where the drying is carried out at temperatures in the range from 300 to 1000° C., preferably in a range from 350 to 450° C. On suitable coating, the drying takes place within a time of less than 5 minutes, preferably giving a layer thickness of <100 nm. For the production of thicker layers, the drying conditions must be varied correspondingly on application of thicker layers. If the drying is carried out at high temperatures under so-called heat-treatment conditions above 1000° C., hard, crystalline layers form which have a comparable structure to corundum. At temperatures below 500° C., dried Al₂O₃ (hybrid) layers form, which can be etched using most inorganic mineral acids, but preferably by HF and H₃PO₄, and by many organic acids, such as acetic acid, propionic acid and the like. Simple post-structuring of the layers obtained is thus possible. Suitable substrates for the coating with the inks according to the invention are mono- or multicrystalline silicon wafers, in particular HF- or RCA-cleaned wafers, or also sapphire wafers, or thin-film solar modules, glasses coated with functional materials, such as, for example, ITO, FTO, AZO, IZO or comparable materials, uncoated glasses, steel elements and alloys, especially in the automobile sector, and other materials used in microelectronics. In accordance with the substrates used, the layers formed through the use of the inks can serve as diffusion barrier, printable dielectric, electronic and electrical passivation, antireflection coating, mechanical protection layer against wear chemical protection layer against oxidation or the action of acid.

The sol-gel inks and/or pastes which can be employed for this purpose should be formulated in such a way that printable formulations are obtained which preferably result in layer thicknesses in the range between 20 and 300 nm, particularly preferably in layers having a thickness of between 20 and 100 nm, by means of which excellent electronic surface passivation of semiconducting materials, preferably silicon and silicon wafers, is achieved. The thin Al₂O₃ layers applied and dried in this way advantageously already increase the charge-carrier lifetime. In addition, it has been found that the surface passivation of the layer can be greatly increased again if the applied layers are heat-treated at 350-550° C. for a few minutes after drying, preferably for up to 15 minutes in a nitrogen atmosphere and/or forming-gas atmosphere.

Hybrid materials comprising simple and polymeric boron and phosphorus oxides and alkoxides thereof based on the inks according to the invention can be used for the inexpensive full-area and local doping of semiconductors, preferably silicon, to be precise in the electrical and electronics industry in general, and in the photovoltaics industry in particular, especially in the production of crystalline silicon solar cells and solar modules specifically. Inks and/or pastes according to the invention are printable, and formulations and rheological properties thereof can be matched within broad limits to the needs necessary in each case of the printing method to be used.

On use of Al₂O₃/B₂O₃-containing printable inks and/or pastes for the doping of silicon wafers, preference is given to the use of silicon wafers which have been cleaned with the RCA or a comparable cleaning sequence. The wafer surface may have been rendered hydrophilic or hydrophobic in advance. Simplified cleaning of the wafers is preferably carried out by means of HF solution and etching. The layer remaining on the wafer after the doping process can be easily be removed or etched in a structured manner by means of etching in dilute HF.

For the production of boron-doped aluminium oxide coatings according to the invention, i.e. coatings with local or full-area doping, use can be made of Al₂O₃/B₂O₃-containing printable inks and/or pastes, which result in a molar proportion of diboron trioxide in the doped layer in the range 5-55 mol %, preferably in a proportion in the range 20-45 mol %.

Al₂O₃ prepared in this way can be used as sodium and potassium diffusion barrier in LCD technology. A thin layer of Al₂O₃ on the cover glass of the display here can prevent diffusion of ions from the cover glass into the liquid-crystalline phase, enabling the lifetime of the LCDs to be increased considerably.

### FIGURES AND DIAGRAMS

FIG. 1 shows a scanning electron photomicrograph of a resultant uniform Al₂O₃ layer on a polished (100) silicon wafer.

FIG. 2 shows the temperature-dependent Raman analyses of Al₂O₃ layers formed.

FIG. 3 shows a scanning electron photomicrograph of a polished (100) silicon wafer piece in accordance with Example 7 printed with aluminium sol by ink-jet printing (a) and a curve of the associated EDX analysis (b).

FIG. 4 shows a scanning electron photomicrograph of a (100) silicon wafer piece printed with aluminium/zirconium sol in accordance with Example 8 (a) and a curve of the associated EDX analysis (b).

FIG. 5 shows a scanning electron photomicrograph of a (100) silicon wafer fragment in accordance with Example 9 printed with aluminium sol by ink-jet printing.

FIG. 6 shows a polished (100) silicon wafer piece printed in accordance with Example 10 with aluminium sol by ink-jet printing. The printed field is composed of tracks of various width and various track separation.

FIG. 7 shows the result of a polished (100) silicon wafer fragment coated in accordance with Example 11 with aluminium sol by spin coating.

FIG. 8 shows the plot of the measured charge-carrier lifetime as a function of the minority charge-carrier density, to be precise of an uncoated sample and of samples coated with aluminium oxide in accordance with Example 12 with layer thicknesses of 9 and 17 nm.

FIG. 9 shows the charge-carrier lifetime of an uncoated silicon wafer (top (a)) and a silicon wafer coated on both sides with aluminium oxide in accordance with Example 13 (bottom (b)). The lifetime has increased by a factor of 100 due to the coating.

FIG. 10 shows charge-carrier lifetimes of n-doped Cz wafer samples of uncoated sample (yellow, bottom), of a sample coated with aluminium oxide in accordance with Example 14 (magenta, middle) and a chemically passivated sample (blue, top). The lifetimes are, in this sequence (injection density: 1E+15): 6 μs, ˜120 μs and ˜1000 μs.

FIG. 11 shows the charge-carrier lifetimes of p-doped Cz wafer samples, to be precise an uncoated sample (yellow, bottom), a sample coated with aluminium oxide in accordance with Example 15 (magenta, middle) and a chemically passivated sample (blue, top). The lifetimes are, in this sequence (injection density: 1E+15): 6 μs, ˜65 μs and ˜300 μs.

FIG. 12 shows the plotted charge-carrier lifetimes of p-doped FZ wafer samples, to be precise an uncoated sample (yellow, bottom), a sample coated with aluminium oxide in accordance with Example 16 (magenta, middle) and a chemically passivated sample (blue, top). The lifetimes are, in this sequence (injection density: 1E+15): 7 μs, ˜400 μs and >>1000 μs.

FIG. 13 shows a diffusion profile of the boron doping ink in accordance with Example 17 with a relative proportion by weight of 0.15 (red curve: p or boron doping as a consequence of exposure of the wafer surface to the dried ink, blue curve: n or phosphorus base doping). The layer resistance of the sample is 464/square.

FIG. 14 shows a diffusion profile of the boron doping ink in accordance with Example 17 with a relative proportion by weight of 0.3 (red curve: p or boron doping as a consequence of exposure of the wafer surface to the dried ink, blue curve: n or phosphorus base doping). The layer resistance of the sample is 321/square.

FIG. 15 shows the diffusion profile of the boron doping ink in accordance with Example 18 (red curve: p or boron doping as a consequence of exposure of the wafer surface to the dried ink, blue curve: n or phosphorus base doping). The layer resistance of the sample is 65/square.

The present description enables the person skilled in the art to use the invention comprehensively. Even without further comments, it is therefore assumed that a person skilled in the art will be able to utilise the above description in the broadest scope.

If anything should be unclear, it goes without saying that the cited publications and patent literature should be consulted. Accordingly, these documents are regarded as part of the disclosure content of the present description.

For better understanding and in order to illustrate the invention, two examples are given below which are within the scope of protection of the present invention. These examples also serve to illustrate possible variants. Owing to the general validity of the inventive principle described, however, the examples are not suitable for reducing the scope of protection of the present application to these alone.

Furthermore, it goes without saying to the person skilled in the art that, both in the examples given and also in the remainder of the description, the component amounts present in the compositions always add up only to 100% by weight or 100 mol %, based on the composition as a whole, and cannot exceed this, even if higher values could arise from the percent ranges indicated. Unless indicated otherwise, % data are regarded as % by weight or mol %, with the exception of ratios, which are given in volume data.

The temperatures given in the examples and description and in the Claims are always in ° C.

### EXAMPLES

### Example 1

0.6 g of acetylacetone in 50 ml of isopropanol is initially introduced in a 100 ml round-bottomed flask. 2.5 g of aluminium tri-sec-butoxide are added to the solution, and the mixture is stirred for 10 minutes. 2.3 g of acetic acid are added in order to neutralise the butoxide and adjust the pH of the ink, and the mixture is again stirred for 10 minutes. 1.2 g of water are added in order to hydrolyse the partially protected aluminium alkoxide, and the solution is stirred for 10 minutes and left to stand in order to age. After about 3 hours, the solution becomes cloudy, and a slimy precipitate deposits after about 3 days. The precipitate can be dissolved by addition of 25 ml of water. However, the resultant solution has poor coating properties both on HF- and on RCA-cleaned wafers. Although the wetting properties of the ink are improved by addition of surfactant to the inks prepared in this way, accumulations of solid form within the resultant layer, which are indicated by micelle-like stabilisation of the primary condensates within the ink. The same results are obtained at mixing ratios of aluminium to acetylacetone of between 0.5 and 3, but the amount of water needed to dissolve the precipitate decreases. Larger amounts of water are also needed in order to dissolve the precipitate with citric acid, oxalic acid and ascorbic acid.

### Example 2

0.6 g of acetylacetone in 50 ml of methanol is initially introduced in a 100 ml round-bottomed flask. 2.5 g of aluminium tri-sec-butoxide are added to the solution, and the mixture is stirred for 10 minutes. 2.3 g of acetic acid are added in order to neutralise the butoxide and adjust the pH of the ink, and the mixture is again stirred for 10 minutes. 1.2 g of water are added in order to hydrolyse the partially protected aluminium alkoxide, and the solution is stirred for 10 minutes and left to stand in order to age. The solids content in the solution can be increased to 6% by weight, where the corresponding amounts of acetic acid and acetylacetone should be employed. The solution is stable for months, but methanol has inadequate viscosity in order to be suitable for application by various printing methods. In the case of mixtures of methanol with glycol ethers or isopropanol, precipitate formation occurs within a few days under the same conditions.

### Example 3

0.8 g of salicylic acid in 50 ml of isopropanol is initially introduced in a 100 ml round-bottomed flask. 2.5 g of aluminium tri-sec-butoxide are added to the solution, and the mixture is stirred for 10 minutes. 2.3 g of acetic acid are added in order to neutralise the butoxide and adjust the pH of the ink, and the mixture is again stirred for 10 minutes. 1.2 g of water are added in order to hydrolyse the partially protected aluminium alkoxide, and the solution is stirred for 10 minutes and left to stand in order to age. Immediately after addition of water, a cloudy suspension forms, from which a precipitate only deposits very slowly (over the course of 20 days). The precipitate cannot be dissolved by addition of water.

### Example 4

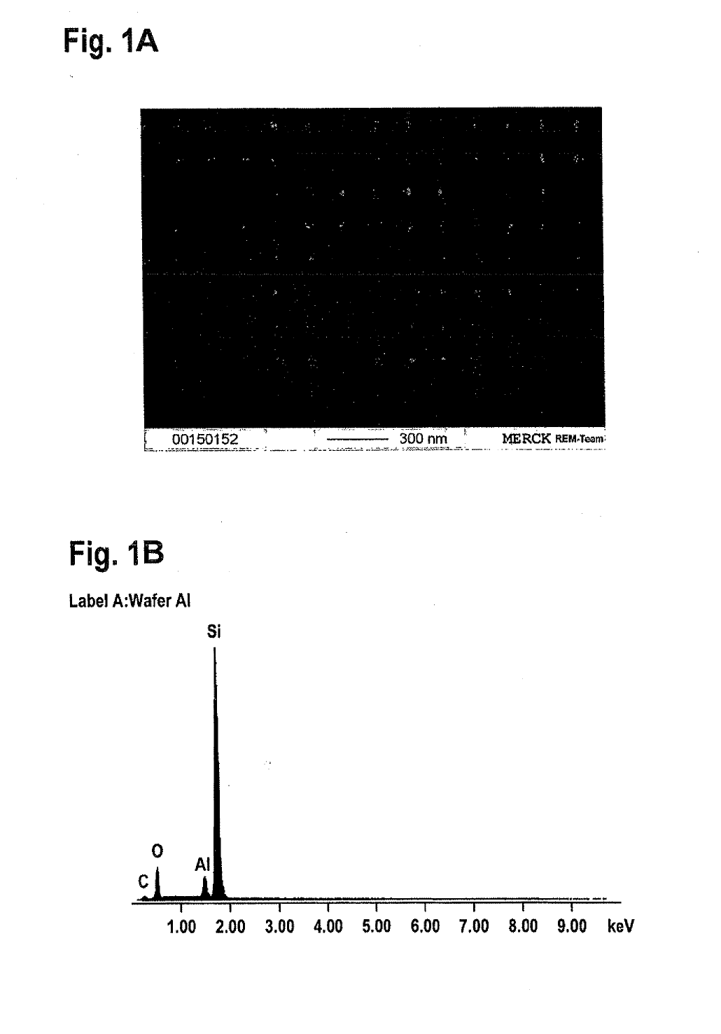

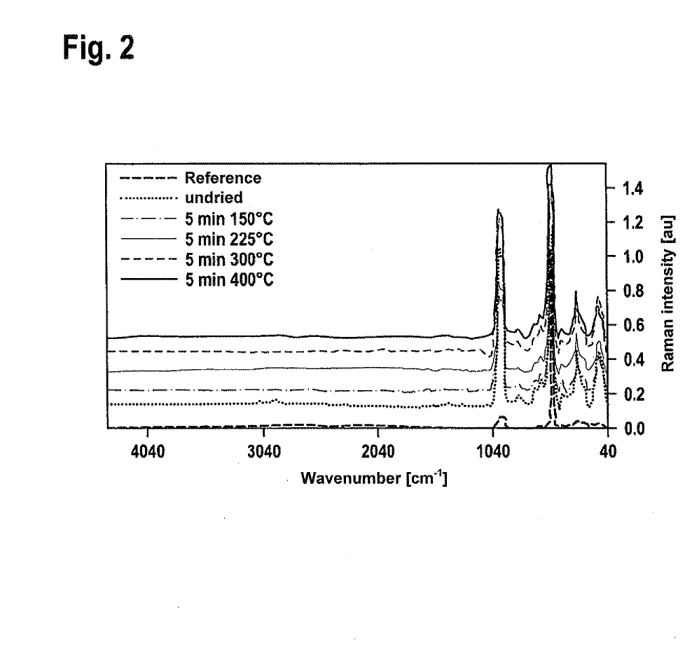

3 g of salicylic acid and 1 g of acetylacetone in 25 ml of isopropanol and 25 ml of diethylene glycol monoethyl ether are initially introduced in a 100 ml round-bottomed flask. 4.9 g of aluminium tri-sec-butoxide are added to the solution, and the mixture is stirred for 10 minutes. 5 g of acetic acid are added in order to neutralise the butoxide and adjust the pH of the ink, and the mixture is again stirred for 10 minutes. 1.7 g of water are added in order to hydrolyse the partially protected aluminium alkoxide, and the slightly yellow solution is stirred for 10 minutes and left to stand in order to age. The solids content can be increased to 6%. The ink exhibits a stability of >3 months with ideal coating properties and efficient drying (see FIGS. 1 and 2).

In addition, hydride-terminated wafers (HF cleaning) can be homogeneously coated with this ink by spin coating. Introduction of boron oxide into this ink enables spin-on dopant layers to be produced, which can easily be etched off by a simple HF dip after diffusion at 1000° C. The layer resistance after doping is 80 Ω/square. This can be adjusted variably by adjustment of the process duration, heat-treatment temperature and boron concentration in the ink. Polyhydroxybenzoic acids can be used as alternative complexing agents to acetylacetone.

### Example 5

2 g of salicylic acid and 0.8 g of acetylacetone in 30 g of diethylene glycol monoethyl ether are initially introduced in a 100 ml round-bottomed flask. 5.2 g of aluminium tri-sec-butoxide and 0.2 g of acetic acid are added to the solution, and the mixture is stirred for 10 minutes. 1.5 g of water are then added in order to hydrolyse the partially protected aluminium alkoxide, and the slightly yellow solution is stirred for 10 minutes and left to stand in order to age.

The solids content can be increased to 10%. In spite of the high water content (n(water)/n(Al)=6.5), the ink exhibits a stability of >200 hours at 50° C. (experiment terminated after this time without a precipitate having formed).

### Note:

At lower water concentrations (<0.7 g), stable inks (>3 months) can also be synthesised without the addition of acetic acid or other acids with retention of the ideal coating properties and efficient drying (see FIGS. 1 and 2). In addition, hybrid-terminated wafers (HF cleaning) can be homogeneously coated with this ink by spin coating. Suitable as further complexing agents instead of acetylacetone are polyhydroxybenzoic acid, with the viscosity of the sol obtained being significantly influenced by the addition of the complexing agents.

### Example 6

An ink is modified in accordance with Example 5 by addition of boron oxide. Introduction of boron oxide into this ink enables spin-on dopant layers to be produced, which can easily be etched off by a simple HF dip after diffusion at >1000° C. The layer resistance of a 150 Ω/square n-type wafer, coated with a spin-on dopant layer of this type, is 80 Ω/square after diffusion at 1050° C., which fits well into the window of conventional boron-doped silicon wafers (50-100 Ω/square).

### Example 7

A titanium oxide/aluminium oxide hybrid sol is prepared in accordance with Example 5. To this end, the precursors aluminium tri-sec-butoxide and titanium tetraethoxide in a molar ratio of 50/50 with a molar ratio of precursor to complexing agent of 0.8 are initially introduced in a solution as outlined in Example 5. Water is subsequently added to the precursor solution (mixing ratio of water to total amount of precursor: 3:1), and the solution is stirred overnight.

After application of the hybrid sol obtained to a wafer and drying at elevated temperature, a uniform, impermeable aluminium oxide/titanium dioxide layer is obtained.

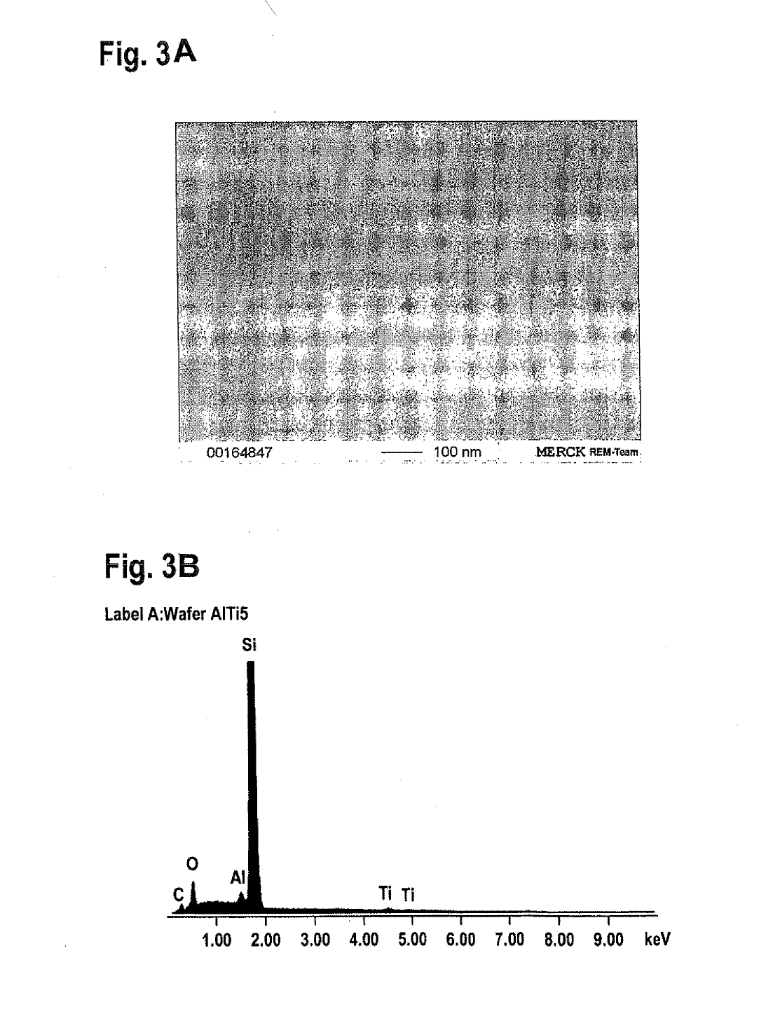

FIG. 3 shows a scanning electron photomicrograph and an EDX analysis of an aluminium oxide/titanium dioxide layer produced in accordance with this example.

### Example 8

A zirconium oxide/aluminium oxide hybrid sol is prepared in accordance with Example 5. To this end, the precursors aluminium tri-sec-butoxide and zirconium tetraethoxide in a molar ratio of 50/50 with a molar ratio of precursor: complexing agent of 0.8 are initially introduced in a solution as outlined in Example 5. Water is subsequently added to the precursor solution (mixing ratio of water to precursor: 3:1), and the solution is stirred overnight.

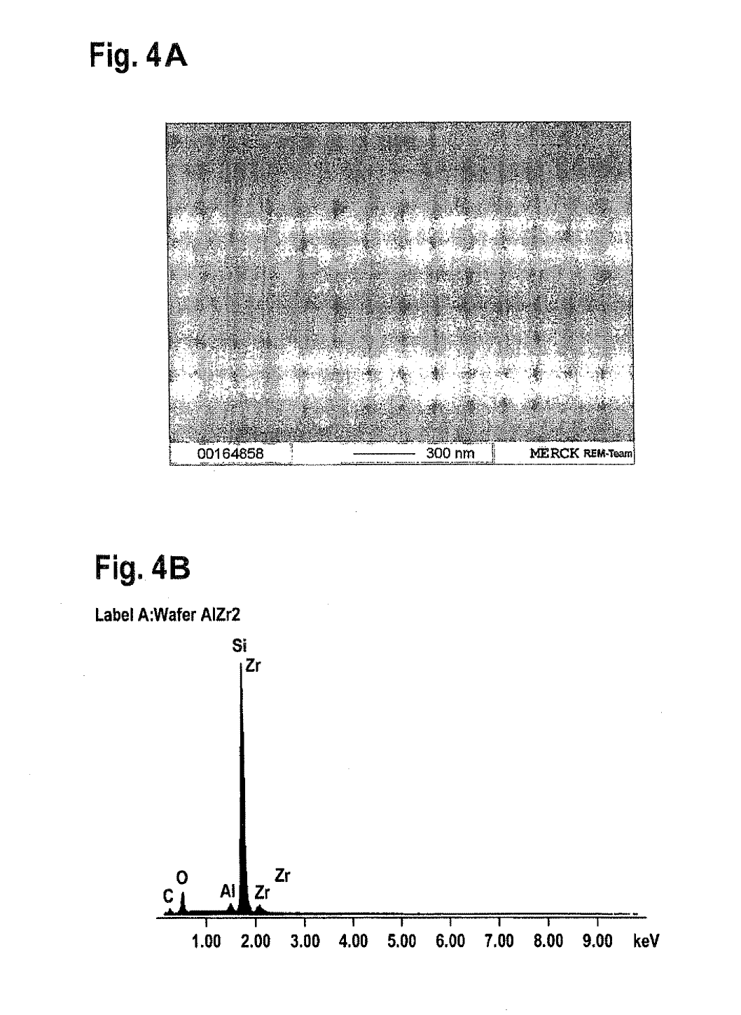

FIG. 4 shows a scanning electron photomicrograph and EDX analysis of an aluminium oxide/zirconium dioxide layer produced in accordance with this example.

### Example 9

After cleaning with RCA-1, a polished (100) silicon wafer piece is printed with an aluminium sol ink in accordance with Example 4 by means of ink-jet printing. The temperature of the substrate is 70° C., and the drop separation during printing is 50 μm. A field measuring 1×1 cm² is printed on. The layer thickness of the pressure-resistant layer is ˜120 nm.

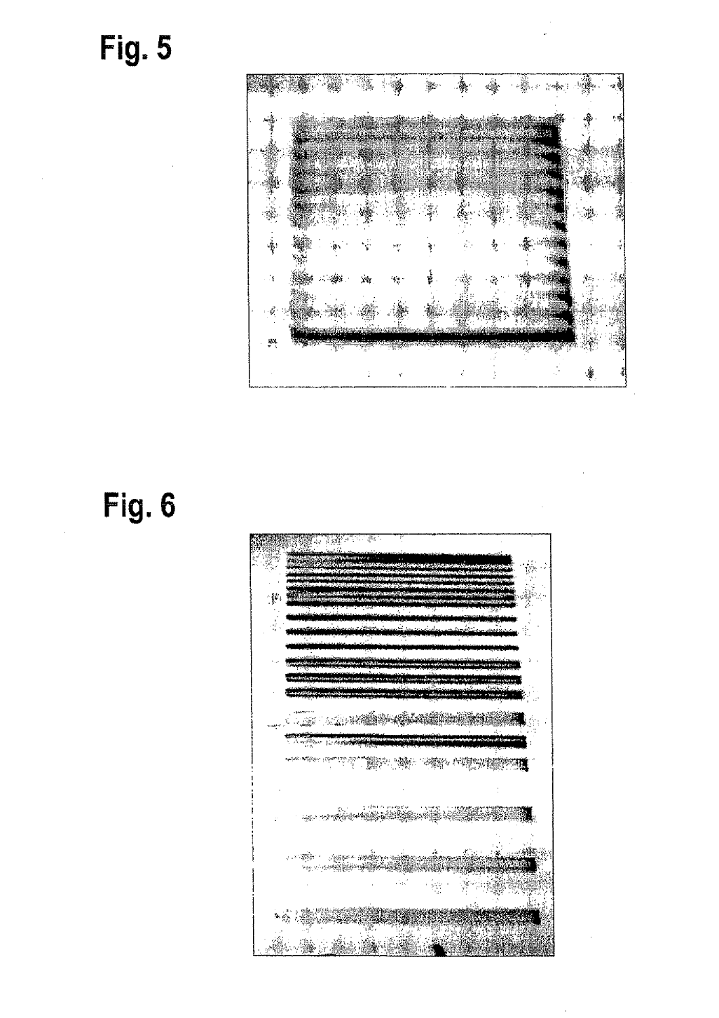

FIG. 5 shows a polished (100) silicon wafer piece printed with aluminium sol by ink-jet printing, as described here.

### Example 10

After cleaning with RCA-1, a polished (100) silicon wafer piece is printed with an aluminium sol ink in accordance with Example 4 by means of ink-jet printing. The temperature of the substrate is 90° C., and the drop separation during printing is 50 μm. A field measuring 1×2 cm², containing tracks of various width and various separation, is printed on.

FIG. 6 shows a polished (100) silicon wafer piece printed with aluminium sol by ink-jet printing. The printed field is composed of tracks of various width and various track separation.

### Example 11

After cleaning with RCA-1, a polished (100) silicon wafer piece is coated with an aluminium sol ink in accordance with Example 4 by means of spin coating and dried at 100° C. on a hotplate.

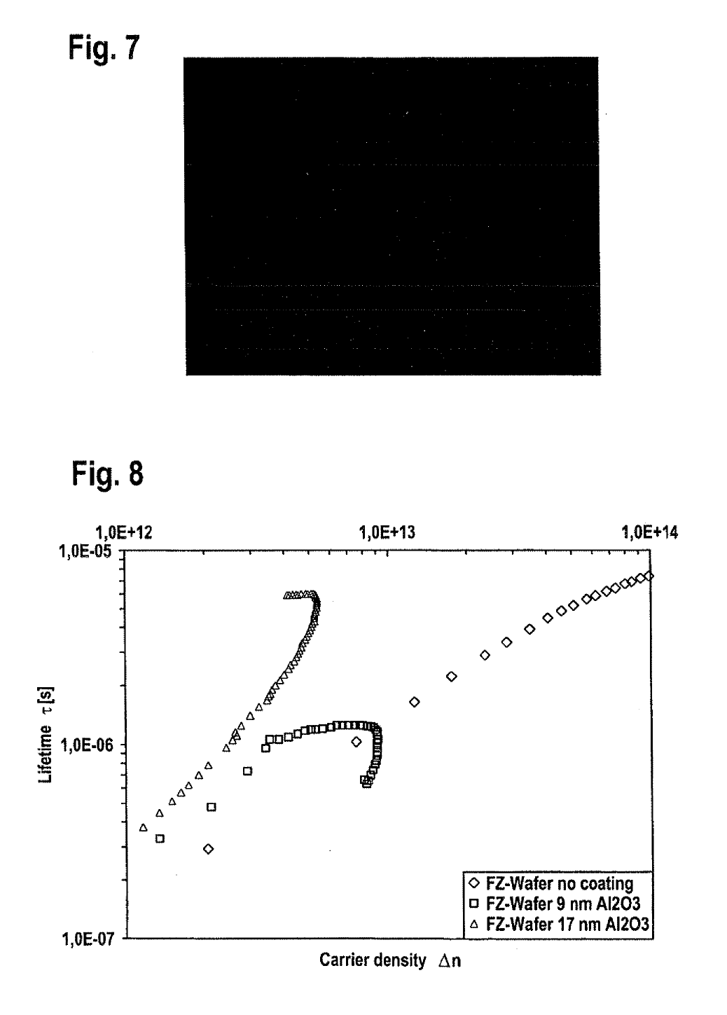

FIG. 7 shows the result for a polished (100) silicon wafer fragment of this type coated with aluminium sol by spin coating.

### Example 12

30 g of diethylene glycol monoethyl ether and 1.5 g of acetic acid are initially introduced in a 100 ml round-bottomed flask. 1.0 g of aluminium tri-sec-butoxide is slowly dissolved in this solution. 0.2 g of water is added for hydrolysis, and the resultant sol is heated at 170° C. for 60 minutes. After cooling, a pale-yellow, transparent and viscous sol remains, which does not have to be stabilised by complexing agents. The concentration by weight of aluminium oxide in this sol is about 1%. By increasing the concentration by weight of aluminium oxide in the sol to 1.5 to 2% by weight, the formation of a white precipitate occurs. It can therefore be assumed that the addition of a stabilising and protecting complexing agent is necessary from a concentration by weight of 1% of aluminium oxide.

The sol is then applied by means of spin coating at a rotational speed of 2000 rpm to a p-doped (100) FZ wafer which has been polished on both sides and has previously been etched with dilute HF, and the sol is subsequently dried for 30 minutes at 400° C. on a hotplate. The aluminium oxide layer thickness, determined by ellipsometry, is 9 nm. A second wafer is coated twice with the sol using the above-mentioned conditions. The layer thickness, measured by ellipsometry, is then 17 nm. The quality of the electronic surface passivation of these two samples is investigated against an uncoated reference sample by means of a WCT-120 photoconductance lifetime tester (QSSPC, quasi steady-state photoconductance).

FIG. 8 shows the measured charge-carrier lifetime as a function of the minority charge-carrier density, more precisely of an uncoated sample and samples coated with aluminium oxide with layer thicknesses of 9 and 17 nm.

It arises from FIG. 8 that the lifetime of the minority charge carriers is virtually independent of the surface treatment present. The coated samples achieved comparable lifetimes, depending on the injection density (minority charge-carrier density). It can be assumed that the with the sol used and the resultant aluminium oxide layer thicknesses on the wafer surface do not contribute to the electronic passivation of the semiconductor surface under the experimental conditions selected. Otherwise, an increase in the lifetime of the minority charge carriers would be observed.

### Example 13

After cleaning with dilute HF, a p-doped (100) FZ silicon wafer piece polished on both sides is coated on both sides with an aluminium oxide sol ink in accordance with Example 5 by means of spin coating and dried at 450° C. on a hotplate. The resultant layer thickness is 60 nm. The charge-carrier lifetime of the wafer is subsequently investigated by means of a WCT-120 photoconductance lifetime tester (QSSPC, quasi steady-state photoconductance).

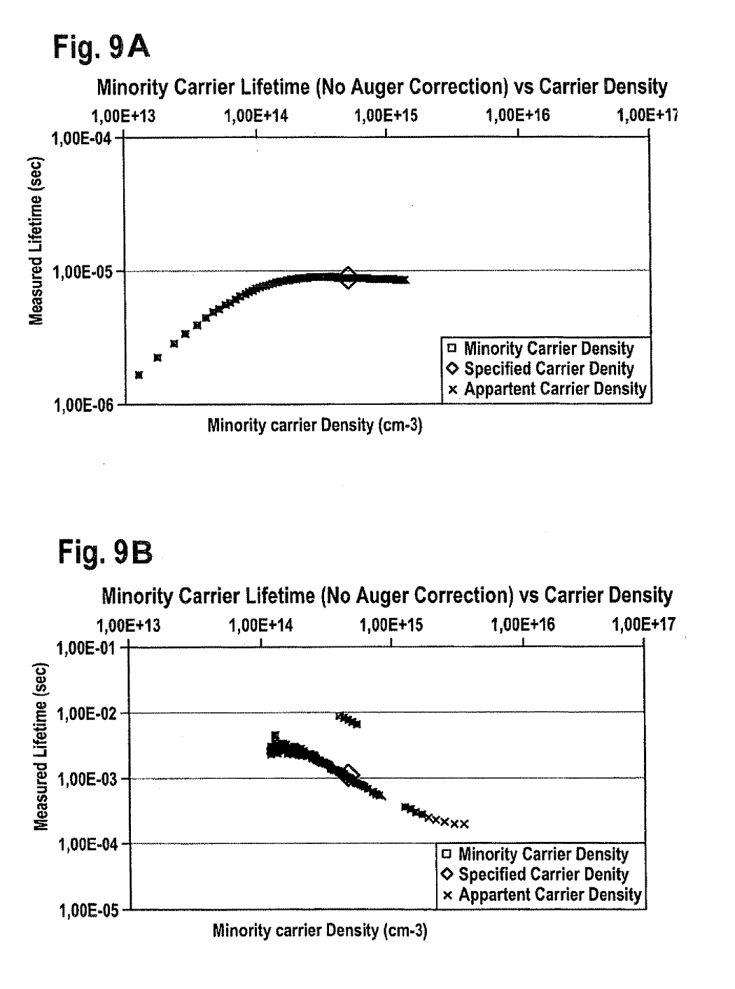

FIG. 9 shows the charge-carrier lifetime of an uncoated silicon wafer (top (a)) and a silicon wafer coated on both sides with aluminium oxide (bottom (b)). The lifetime has increased by a factor of 100 due to the coating.

### Example 14

After cleaning with HF, an n-doped (100) Cz silicon wafer piece polished on one side is coated on both sides with an aluminium oxide sol ink in accordance with Example 5 by means of spin coating and dried at 450° C. on a hotplate. The layer thickness, determined by ellipsometry, is 60 nm. The charge-carrier lifetime of the wafer is subsequently investigated by means of a WCT-120 photoconductance lifetime tester (QSSPC, quasi steady-state photoconductance). Identical wafer samples which are either uncoated or have been treated with the aid of the wet-chemical quinhydrone/methanol method serve as references. The quinhydrone/methanol method (mixture of 1,4-benzoquinone, 1,4-benzohydroquinone and methanol) is a wet-chemical and temporarily effective, i.e. non-long-term-stable, electronic surface passivation. All wafer samples are etched in advance by means of dilute HF.

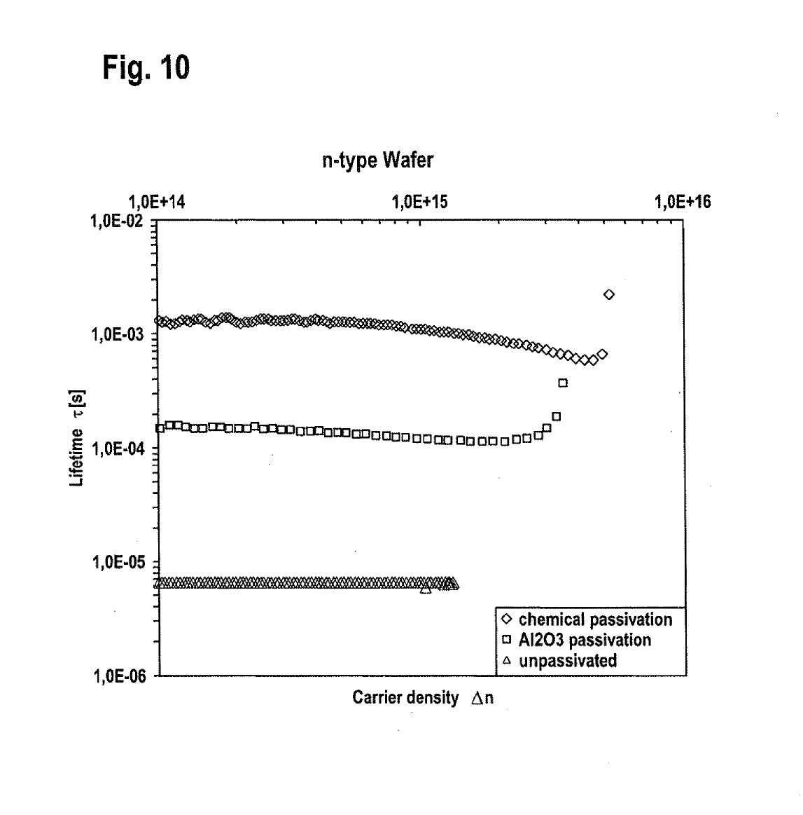

FIG. 10 shows charge-carrier lifetimes of n-doped Cz wafer samples of uncoated sample (yellow, bottom), of a sample coated with aluminium oxide (magenta, middle) and a chemically passivated sample (blue, top). The lifetimes in this sequence are (injection density: 1E+15): 6 μs, ˜120 μs and ˜1000 μs.

An increase in the lifetime by a factor of 20 can be determined compared with the uncoated sample. The increase in the carrier lifetime is attributable to the action of the aluminium oxide as electronic surface passivation of the semiconducting material.

### Example 15

After cleaning with HF, a p-doped (100) Cz silicon wafer piece polished on one side is, coated on both sides with an aluminium oxide sol ink in accordance with Example 5 by means of spin coating and dried at 450° C. on a hotplate. The layer thickness, determined by ellipsometry, is 60 nm. The charge-carrier lifetime of the wafer is subsequently investigated by means of a WCT-120 photoconductance lifetime tester (QSSPC, quasi steady-state photoconductance). Identical wafer samples which are either uncoated or have been treated with the aid of the wet-chemical quinhydrone/methanol method serve as references. The quinhydrone/methanol method (mixture of 1,4-benzoquinone, 1,4-benzohydroquinone and methanol) is a wet-chemical and temporarily effective, i.e. non-long-term-stable, electronic surface passivation. All wafer samples have been etched in advance by means of dilute HF.

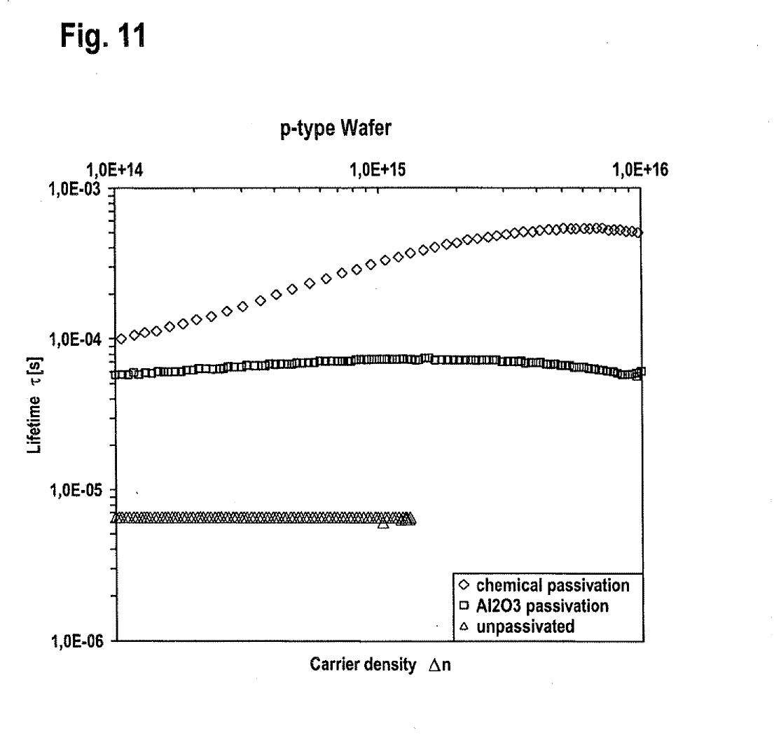

FIG. 11 shows the charge-carrier lifetimes of p-doped Cz wafer samples, to be precise an uncoated sample (yellow, bottom), a sample coated with aluminium oxide (magenta, middle) and a chemically passivated sample (blue, top). The various lengths of the lifetime in this sequence are (injection density: 1E+15): 6 μs, ˜65 μs and ˜300 μs.

An increase in the lifetime by a factor of 10 can be determined compared with the uncoated sample. The increase in the carrier lifetime is attributable to the action of the aluminium oxide as electronic surface passivation of the semiconducting material.

### Example 16

After cleaning with HF, a p-doped (100) FZ silicon wafer piece polished on both sides is coated on both sides with an aluminium oxide sol ink in accordance with Example 5 by means of spin coating and dried at 450° C. on a hotplate. The layer thickness, determined by ellipsometry, is subsequently 60 nm. The charge-carrier lifetime of the wafer is subsequently investigated by means of a WCT-120 photoconductance lifetime tester (QSSPC, quasi steady-state photoconductance). Identical wafer samples which are either uncoated or have been treated with the aid of the wet-chemical quinhydrone/methanol method serve as references. The quinhydrone/methanol method (mixture of 1,4-benzoquinone, 1,4-benzohydroquinone and methanol) is a wet-chemical and temporarily effective, i.e. non-long-term-stable, electronic surface passivation. All wafer samples have been etched in advance by means of dilute HF.

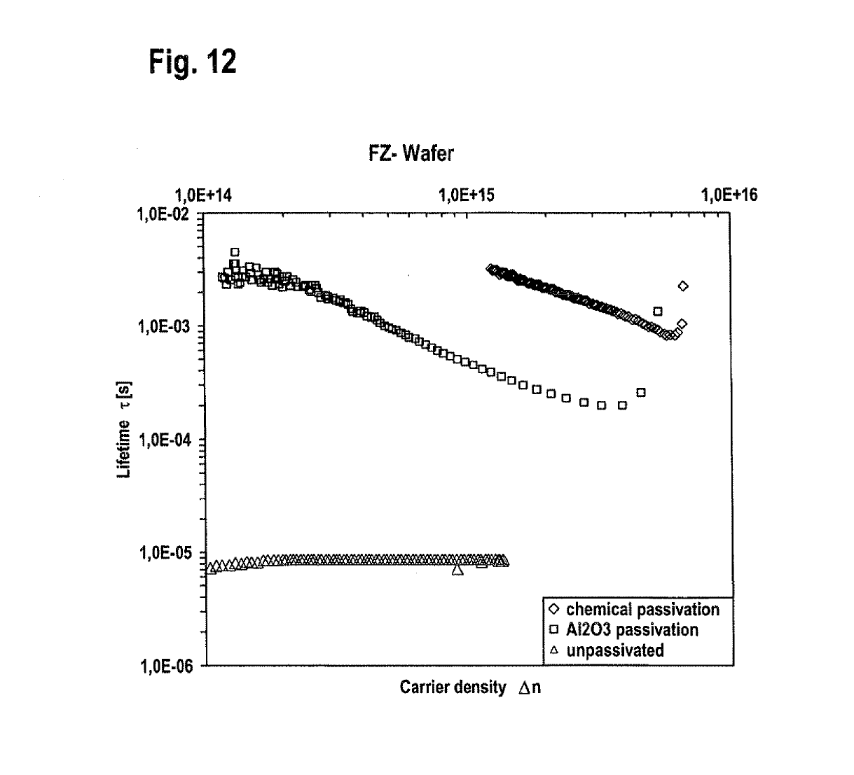

In FIG. 12, the various charge-carrier lifetimes of p-doped FZ wafer samples are plotted, to be precise an uncoated sample (yellow, bottom), a sample coated with aluminium oxide (magenta, middle) and a chemically passivated sample (blue, top). The various lengths of the lifetime are, in this sequence (injection density: 1E+15): 7 μs, ˜400 μs and >>1000 μs.

An increase in the lifetime by a factor of ˜60 can be determined compared with the uncoated sample. The increase in the carrier lifetime is attributable to the action of the aluminium oxide as electronic surface passivation of the semiconducting material.

### Example 17

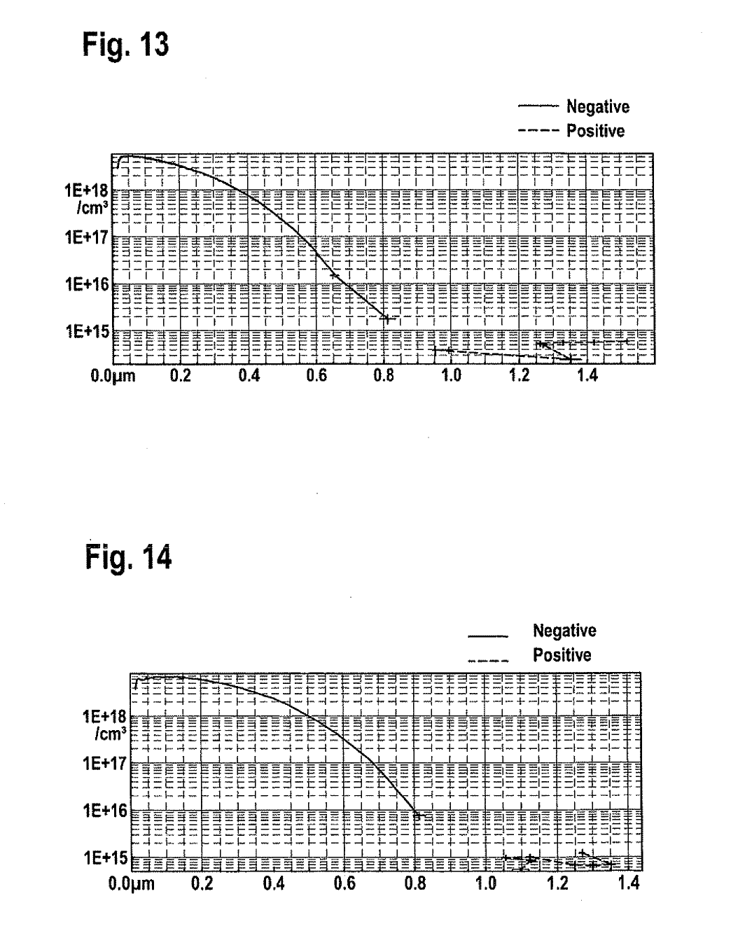

A boron-based doping ink is prepared in accordance with Example 4. The weight ratios therein are: diethylene glycol monoethyl ether:aluminium tri-sec-butoxide:acetic acid:water: salicylic acid 30:5:1:1.2:1. The proportion of boron trioxide is 0.05-0.3. After spin coating of an n-type silicon wafer (Cz, 10 Ω*cm, polished on one side, (100)) at 2000 rpm for 30 s and subsequent drying for 5 minutes on a hotplate at 300° C., a layer thickness of about 70 nm results. This sample is subjected to a diffusion process in a muffle furnace under standard atmospheric conditions (diffusion conditions: 30 minutes at 950° C.). FIGS. 13 and 14 show the resultant doping profiles of samples with relative weight ratios of boron oxide of 0.15 and 0.3. The doping profiles were determined by means of the ECV (electrochemical capacitance voltage profiling) technique.

FIG. 13 shows a diffusion profile of the boron doping ink with a relative proportion by weight of 0.15 (red curve: p or boron doping as a consequence of exposure of the wafer surface to the dried ink, blue curve: n or phosphorus base doping). The layer resistance of the sample is 464/square.

FIG. 14 shows a diffusion profile of the boron doping ink with a relative proportion by weight of 0.3 (red curve: p or boron doping as a consequence of exposure of the wafer surface to the dried ink, blue curve: n or phosphorus base doping). The layer resistance of the sample is 321/square.

### Example 18

1.5 g of salicylic acid and 1 g of acetylacetone in 25 ml of diethylene glycol monoethyl ether are initially introduced in a 100 ml round-bottomed flask. 5.7 g of aluminium tri-sec-butoxide are added to the solution, and the mixture is stirred for 10 minutes. 0.75 g of diboron trioxide is added to this solution as dopant, and the mixture is stirred until the boron oxide has dissolved without leaving a residue. 1 g of acetic acid is added in order to neutralise the butoxide and adjust the pH of the ink, and the mixture is again stirred for 10 minutes. 1.7 g of water are added in order to hydrolyse the partially protected aluminium alkoxide, and the slightly yellow solution is stirred for 10 minutes and left to stand in order to age. The solids content can be increased to 6%. The ink exhibits a stability of >3 months with ideal coating properties and efficient drying. After spin coating of an n-type silicon wafer piece (Cz, 10 Ω*cm, polished on one side, (100)) at 1000 rpm followed by diffusion at 1000° C. for 30 minutes in a standard muffle furnace under standard atmospheric conditions, the doping profile shown in FIG. 14 with an associated layer resistance of <80 Ω/square can be measured by means of the ECV (electrochemical capacitance voltage profiling) technique.

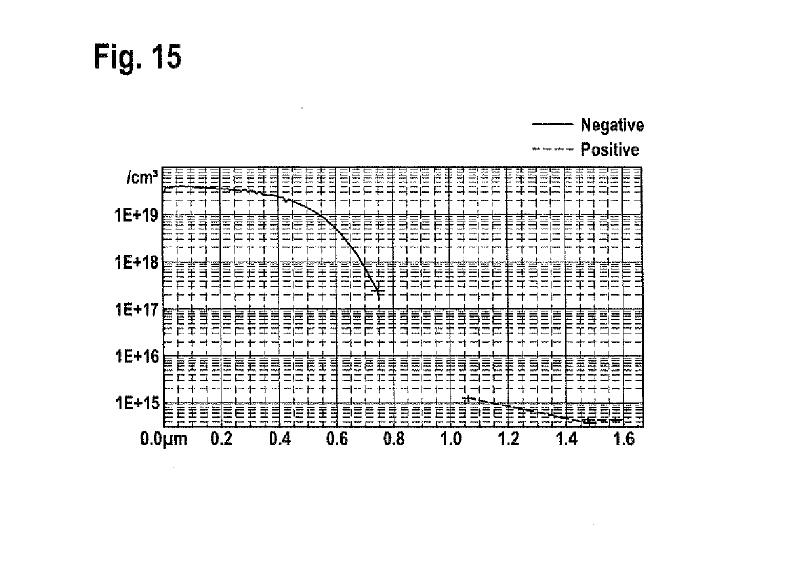

FIG. 15 shows the diffusion profile of the boron doping ink in accordance with Example 18 (red curve: p or boron doping as a consequence of exposure of the wafer surface to the dried ink, blue curve: n or phosphorus base doping). The layer resistance of the sample was 65/square.

1. A layer comprising homogeneous Al₂O₁ coatings or mixed Al₂O₃ hybrid layers as a diffusion barrier or electronic or electrical passivation layer derived from printable sterically stabilised inks wherein
a) the inks' layer-forming components are adjusted in relation to one another so that the solids content is between 0.5 and 10% by weight, preferably between 1 and 6% by weight,
b) the inks used are sterically stabilised by mixing with at least one hydrophobic component, at least one hydrophilic compound selected from the group acetylacetone, dihydroxybenzoic acid and trihydroxybenzoic acid or structurally related compounds thereof and optionally with at least one chelating agent, and
c) the inks are mixed with water in a molar ratio of water to precursor between 1:1 and 1:9, preferably between 1:1.5 and 1:1.25 for hydrolysis of the alkoxides present.

2. A layer according to claim 1 wherein the inks comprise precursors for the formation of Al₂O₃ and for the formation of one or more of the oxides of the elements, selected from the group boron, gallium, silicon, germanium, zinc, tin, phosphorus, titanium, zirconium, yttrium, nickel, cobalt, iron, cerium, niobium, arsenic and lead oxides, where the inks are obtained by introduction of corresponding precursors into the ink.

3. (canceled)

4. A layer according to claim 1 wherein the inks comprise at least one hydrophobic component selected from the group 1,3-cyclohexadione, salicylic acid and structurally related compounds, and at least one hydrophilic compound selected from the group acetylacetone, dihydroxybenzoic acid and trihydroxybenzoic acid or structurally related compounds thereof, chelating agents, such as ethylenediaminetetraacetic acid (EDTA), diethylenetriaminepentaacetic acid (DETPA), nitrilotriacetic acid (NTA), ethylenediaminetetramethylenephosphonic acid (EDTPA) and diethylenetriaminepentamethylenephosphonic acid (DETPPA) or structurally related complexing agents or corresponding chelating agents.

5. A layer according to claim 1 wherein the inks comprise solvents selected from the group of the low-boiling alcohols, preferably selected from the group ethanol and isopropanol, and at least one high-boiling alcohol selected from the group of the high-boiling glycol ethers, preferably selected from the group diethylene glycol monoethyl ether, ethylene glycol monobutyl ether and diethylene glycol monobutyl ether or mixtures thereof, and optionally polar solvents selected from the group acetone, DMSO, sulfolane and ethyl acetate, or similar polar solvents.

6. A layer according to claim 1 wherein the inks have an acidic pH in the range 4-5 and comprise, as acids, one or more organic acids which result in residue-free drying.

7. (canceled)

8. A layer according to claim 1 which comprises a diffusion barrier, a printed dielectric, an electronic and electrical passivation layer, an antireflection coating, a mechanical protection layer against wear, a chemical protection layer against oxidation or the action of acid.

9. A layer according to claim 1 which comprises hybrid materials comprising simple and polymeric boron and phosphorus oxides and alkoxides thereof for the full-area and local doping of semiconductors, preferably silicon.

10. A layer according to claim 1 which comprises hybrid layers which have a boron trioxide content in the range 5-55 mol %, preferably in the range 20-45 mol %.

11. A layer according to claim 1 which comprises Al₂O₃ layers as sodium and potassium diffusion barriers in LCD technology.

12. Process for the production of pure residue-free amorphous Al₂O₃ layers on mono- or multicrystalline silicon wafers, sapphire wafers, thin-film solar modules, glasses coated with functional materials (for example ITO, FTO, AZO, IZO or the like), uncoated glasses, steel elements and alloys, and on other materials used in microelectronics, characterised in that, after application of a thin layer of ink according to claim 1, the drying is carried out at temperatures between 300 and 1000° C., preferably at 300 to 450° C.

13. Process according to claim 12, characterised in that, before application of the ink, the surface, which is optionally hydrophobically or hydrophilically terminated form, is cleaned, preferably by etching with HF solution or water.

14. Process according to claim 12, characterised in that drying and heat-treatment at temperatures from 1000° C. gives hard, crystalline layers having comparable properties to corundum.

15. Process according to claim 12, characterised in that the drying is carried out within a few minutes, preferably within a time of less than 5 minutes, where a layer having a thickness in the range from 20 to 300 nm, preferably of less than 100 nm, which has surface-passivating properties is formed from the printed-on sol-gel composition.

16. Process according to claim 12 for the production of pure, residue-free, amorphous, structurable Al₂O₃ layers, characterised in that the drying is carried out at temperatures between 300° C. and 500° C. after application of a thin layer of ink, optionally followed by a heat-treatment step, which is carried out at temperatures of 350 to 550° C. under a nitrogen and/or forming-gas atmosphere.

17. Printable, sterically stabilised inks for the formation of dense, homogeneous Al₂O₃ coatings or mixed Al₂O₃ hybrid layers as diffusion barrier and for electronic or electrical passivation, characterised in that they
a) comprise layer-forming components adjusted in relation to one another so that the solids content in the ink is between 0.5 and 10% by weight, preferably between 1 and 6% by weight,
b) are sterically stabilised by mixing with at least one hydrophobic component, at least one hydrophilic compound selected from the group acetylacetone, dihydroxybenzoic acid and trihydroxybenzoic acid or structurally related compounds thereof, and optionally with at least one chelating agent,
and
c) for hydrolysis, the alkoxides present are mixed with water in a molar ratio of water to precursor between 1:1 and 1:9, preferably between 1:1.5 and 1:1.25.
